(19) United States
(12) Patent Application Publication
(10) Pub. No.: US 2025/0061161 A1
(43) Pub. Date: Feb. 20, 2025

(54) DISPENSER IDENTIFICATION SYSTEM

(71) Applicant: BUNN-O-MATIC CORPORATION, Springfield, IL (US)

(72) Inventors: Aaron TURNER, Springfield, IL (US); Marc ANDERSON, Springfield, IL (US); Edward EBELING, Springfield, IL (US); Keith M. RIPPERDA, Springfield, IL (US); Prashanth SANKARAN, Springfield, IL (US)

(21) Appl. No.: 18/724,395

(22) PCT Filed: Dec. 22, 2022
(86) PCT No.: PCT/US2022/053822

§ 371 Date: Jun. 26, 2024

Related U.S. Application Data
(60) Provisional application No. 63/294,631, filed on Dec. 29, 2021.

(51) Int. Cl. G06F 16/955; G06Q 30/02

(52) U.S. Cl. CPC G06F 16/9554; G06Q 30/0281

(57) ABSTRACT

A QR code proxy system allows digital dispenser assets associated with QR codes on a plurality of dispensers to be externally controlled. The specific digital dispenser assets associated with static QR codes can be changed without needing to change the QR codes themselves by editing a routing map. In some embodiments, the system may include a content/media routing map and a proxy engine. The content/media routing map establishes an association between a plurality of dispensers each with a respective QR code and a plurality of digital dispenser assets. The proxy engine determines an identity of a dispenser based on its QR code and responds with one or more digital dispenser assets based on the association established by the content/media routing map.

### RELATED APPLICATIONS

This application claims the benefit of U.S. Provisional Application Ser. No. 63/294,631 filed Dec. 29, 2021 for a “Dispenser Identification System,” which is hereby incorporated by reference in its entirety.

### BACKGROUND

Many products, such as dispensers, come with a variety of operating guides, maintenance instructions, and other media assets. For commercial products, some companies have customized guides for their employees to follow, such as company-specific cleaning instructions for dispensers used in their business locations. In some cases, these guides and instructions are accessible via the internet, but finding the appropriate guide or instructions can be time-consuming and cause difficulties. Moreover, management of these media assets can be difficult.

Therefore, there is a need to overcome one or more of these difficulties.

### SUMMARY

According to one aspect, this disclosure provides a QR code proxy system with a content/media routing map and a proxy engine. The content/media routing map is to establish an association between a plurality of dispensers each with a respective QR code and a plurality of digital dispenser assets. The proxy engine is to: (i) determine an identity of a dispenser of the plurality of dispensers based on a QR code; and (ii) respond with one or more digital dispenser assets based on the association established by the content/media routing map.

According to another aspect, this disclosure provides one or more non-transitory, computer-readable storage media. The media has a plurality of instructions stored thereon that, in response to being executed, cause a computing device to: establish an association between a plurality of dispensers each with a respective QR code and a plurality of digital dispenser assets; determine an identity of a dispenser of the plurality of dispensers based on a QR code; and respond with one or more digital dispenser assets based on the association established by the content/media routing map.

According to a further aspect, this disclosure provides a computer-implemented method in which an association is established between a plurality of dispensers each with a respective QR code and a plurality of digital dispenser assets. The method includes the step of determining an identity of a dispenser of the plurality of dispensers based on a QR code. Additionally, the method includes responding with one or more digital dispenser assets based on the association established by the content/media routing map.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a dispenser identification system;

FIG. 2 is a simplified block diagram of at least one embodiment of various environments of the QR code proxy system of FIG. 1;

FIG. 3 is a simplified routing map of the QR code proxy system of at least one embodiment of various environments of the dispenser identification system of FIG. 1;

FIG. 4 is a simplified flow diagram of a method by which the QR code proxy system distributes content/assets based on the association between a dispenser identification and media routing map according to at least one embodiment of the dispenser identification system of FIG. 1; and

FIG. 5 is a simplified flow diagram of a method by which the QR code proxy system distributes different content/assets based on edits to the media routing map according to at least one embodiment of the dispenser identification system of FIG. 1.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

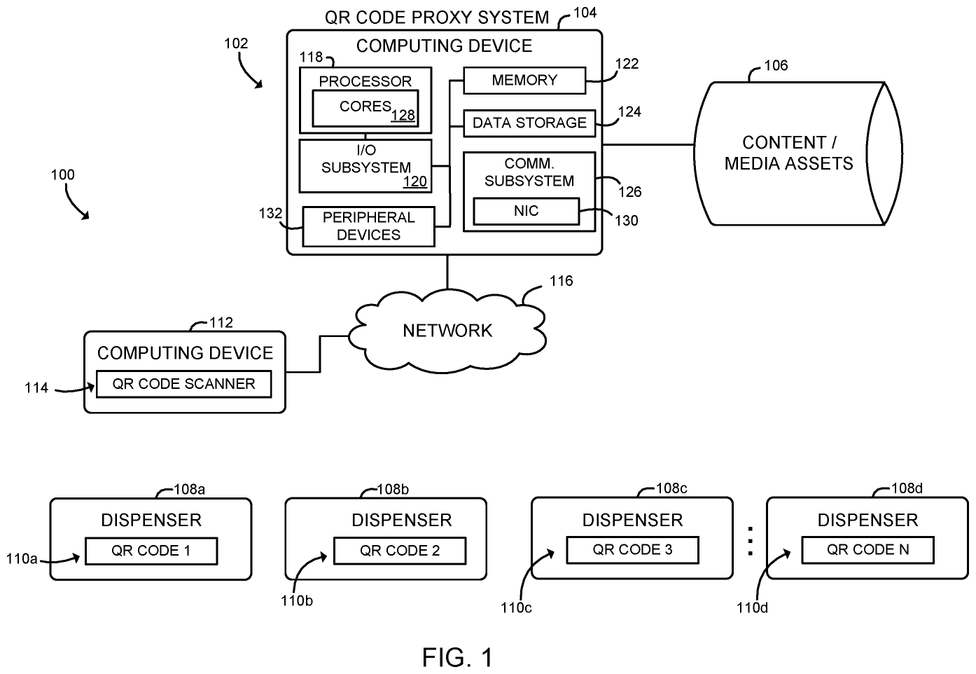

In some embodiments, this disclosure addresses a number of technical problems. For example, the dispenser identification system allows granular management of digital dispenser assets, including but not limited to digital media assets, such as documents, videos, audio, multimedia, etc., digital assets for servicing the dispenser, and digital support/technology assets. In some embodiments, the system allows the behavior of QR codes to be externally controlled. For example, the system can be configured to change the digital media asset(s) that are associated with QR codes; this allows the digital media that is shown in response to scanning a QR code to be changed by the system. The QR code can be static on the dispenser, but the network location of the digital media asset shown in response to scanning the QR code can be adjusted by the system. This allows control and adjustability of content/media associated with a specific dispenser without changing the QR code itself. By way of another example, consider an example in which the digital dispenser asset is a digital asset for servicing the dispenser, a customer could request service by scanning the QR code and the service request could have information pre-populated. Consider another example in which the digital dispenser asset is a digital support/technology asset. The dispenser could be configured to send a message to a remote server if a malfunction or other alert is detected. This could prompt a customer support person to designate an appropriate digital support/technology asset information for the dispenser, which allows the customer to obtain pre-identified support/technology assets upon scanning the QR code. FIG. 1 illustrates an embodiment of a dispenser identification system 100 with a QR code proxy system 102 executing on one or more computing devices 104. The QR code proxy system 102 is configured to control association of digital dispenser assets 106 with QR codes of dispensers. This allows dispensers to be identified based on QR code and the digital dispenser assets managed to specify the specific digital dispenser assets for each dispenser in response to scanning the QR code of the dispenser. As used herein, the term “digital dispenser asset” is broadly meant to encompass any digital content, such as digital media assets, digital assets for servicing the dispenser, and/or digital support/technology assets related to the dispenser.

In the example shown in FIG. 1, there are a plurality of dispensers 108a, 108b, 108c, 108d each with a unique QR code 110a, 110b, 110c, 110d. The term “dispenser” is broadly intended to mean any type of device that dispenses a liquid-like substance, such as a beverage (e.g., coffee, tea, soda, juice, etc.) or a food product (e.g., soup, dressing, condiment, ice cream, etc.). The QR code 110a, 110b, 110c, 110d on the dispenser may be embodied as a label or sticker or could be shown on a screen of the dispenser. Although four dispensers 108a, 108b, 108c, 108d are shown for purposes of example, more or less dispensers could be provided depending on the circumstances.

For example, the QR codes 110a, 110b, 110c, 110d may each embed a global identifier with a URL, which allows each of the dispensers 108a, 108b, 108c, 108d to be uniquely identified. By way of example only, the global identifier could be the serial number of the dispenser. In some cases, the global identifier may be a random or pseudo-random alphanumeric sequence (e.g., 16 or 32 character sequence) that uniquely identifies a dispenser. Of course, the exact length of the global identifier may vary based on the circumstances. By way of example, the URL embedded in the QR code may be a network address of the QR code proxy system 104.

In the example shown, there is a computing device 112 that includes a QR code scanner 114, such as a camera, for scanning the QR codes 110a, 110b, 110c, 110d. Depending on the circumstances, the computing device 112 could be a mobile device, such as phone or tablet, or a notebook computer or any other type of computing device that is capable of scanning a QR code. When the QR code scanner 114 scans one of the QR codes 110a, 110b, 110c, 110d, the computing device 112 is provided with digital dispenser assets, which are embodied as content/media assets 106 associated with the scanned QR code via the network 116.

Although a single computing device 104 for executing the QR code proxy system 102 is shown in this example, the computing device 104 may comprise multiple computing devices that are connected to each other. The computing device 104 may be embodied as any type of computation or computer device capable of performing the functions described herein, including, without limitation, a computer, a server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 104 may be embodied as one or more compute sleds, memory sleds, or other racks, sleds, computing chassis, or other components of a physically disaggregated computing device.

As shown in FIG. 1, the computing device 104 illustratively includes a processor 118, an input/output subsystem 120, a memory 122, a data storage device 124, a communication subsystem 126, and/or other components and devices commonly found in a server or similar computing device. Of course, the computing device 104 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 122, or portions thereof, may be incorporated in the processor 118 in some embodiments.

The processor 118 may be embodied as any type of processor capable of performing the functions described herein. The processor 118 may be a multi-core processor, however, in other embodiments the processor 118 may be embodied as a single or multi-core processor(s), digital processor, microcontroller, or other processor or processing/controlling circuit. The illustrative processor 118 includes multiple processor cores 128, each of which is an independent, general-purpose processing unit capable of executing programmed instructions.

The memory 122 may be embodied as any type of volatile or non-volatile memory or data storage capable of performing the functions described herein. In operation, the memory 122 may store various data and software used during operation of the computing device 104 such operating systems, applications, programs, libraries, and drivers. The memory 122 is communicatively coupled to the processor 118 via the I/O subsystem 120, which may be embodied as circuitry and/or components to facilitate input/output operations with the processor 118, the memory 122, and other components of the computing device 104. For example, the I/O subsystem 120 may be embodied as, or otherwise include, memory controller hubs, input/output control hubs, sensor hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 120 may form a portion of a system-on-a-chip (SoC) and be incorporated, along with the processor 118, the memory 122, and other components of the computing device 104, on a single integrated circuit chip. Similarly, the data storage device 124 may be embodied as any type of device or devices configured for short-term or long-term storage of data such as, for example, memory devices and circuits, memory cards, hard disk drives, solid-state drives, non-volatile flash memory, or other data storage devices.

The computing device 104 also include the communication subsystem 126, which may be embodied as any communication circuit, device, or collection thereof, capable of enabling communications between the computing device 104 and possibly other remote devices over the computer network 116. For example, the communication subsystem 126 may be embodied as or otherwise include a network interface controller (NIC) 130 or other network controller for sending and/or receiving network data with remote devices, such as computing device 112. The NIC 130 may be embodied as any network interface card, network adapter, host fabric interface, network coprocessor, or other component that connects the computing device 104 to the network 116. The communication subsystem 126 may be configured to use any one or more communication technology (e.g., wired or wireless communications) and associated protocols (e.g., Ethernet, InfiniBand®, Bluetooth®, Wi-Fi®, WiMAX, 3G, 4G LTE, etc.) to effect such communication. In some embodiments, the communication subsystem 126 and/or the NIC 130 may form a portion of a SoC and be incorporated along with the processor 118 and other components of the computing device 104 on a single integrated circuit chip.

The computing device 104 may further include one or more peripheral devices 132. The peripheral devices 132 may include any number of additional input/output devices, interface devices, and/or other peripheral devices. For example, in some embodiments, the peripheral devices 132 may include a touch screen, graphics circuitry, a graphical processing unit (GPU) and/or processor graphics, an audio device, a microphone, a camera, a keyboard, a mouse, a network interface, and/or other input/output devices, interface devices, and/or peripheral devices.

The network 116 may be embodied as any number of various wired and/or wireless networks. For example, the network 116 may be embodied as, or otherwise include, a wired or wireless local area network (LAN), and/or a wired or wireless wide area network (WAN). As such, the network 116 may include any number of additional devices, such as additional computers, routers, and switches, to facilitate communications between the computing device 112 and computing device 104.

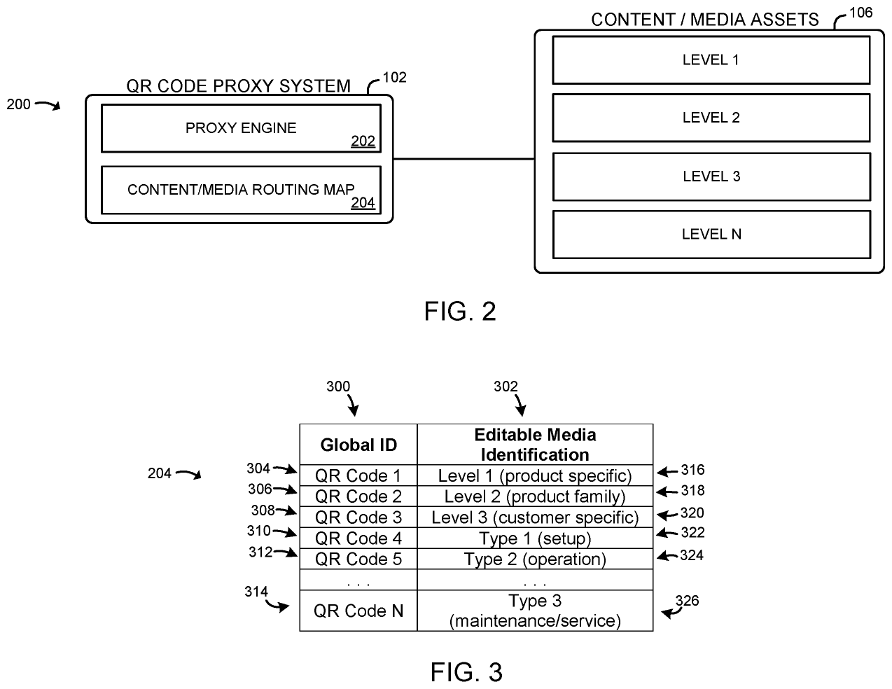

Referring now to FIG. 2, the computing device 104 establishes an environment 200 during operation to perform one or more of the actions described herein. In the embodiment shown, the environment 200 includes a QR code proxy system 102 with a proxy engine 202 and a content/media routing map 204. As shown, the QR code proxy system 102 has access to content/media assets 106. The content/media assets 106 could be a plurality of audio, video, and/or textual information. By way of example only, the content/media assets 106 could be user manuals, operating instruction manuals, instructional videos, cleaning instruction manuals, cleaning instructional videos, technical troubleshooting manuals, troubleshooting videos, and/or servicing manuals or videos for one or more dispensers.

Depending on the circumstances, there may be one or more types of metadata associated with one or more of the content/media assets 106. In some cases, the content/media assets 106 could be categorized with metadata into a plurality of levels or categories. In the example shown, the content/media assets 106 could be tagged with metadata into a Level 1 type, a Level 2 type, a Level 3, and/or a Level N type. Of course, there could be more than four or less than four categories depending on the circumstances. Depending on the circumstances, the content/media assets 106 could have one or more other types of metadata.

In some cases, the levels or categories of metadata may be hierarchical in nature, such as a hierarchy that goes from media that is most specific to a product to less specific to the product. By way of example, a Level 1 type could indicate a media asset that is specific to a particular product model; a Level 2 type could indicate a media asset that is specific to that model's product family (e.g., at a higher level on the hierarchy), but not specific to the product model; Level 3 type could be a media asset more generally-related to the product, such as videos/documentation relating the manufacturer's dispenser products, but not specific to a product or product family. In some cases, the content/media assets 106 could be categorized in other ways. For example, Level 1 could be specific to the product model, Level 2 could be specific to a company's instructions for that product model. For example, the dispenser could be a commercial product that the company owns and has company-specific instructions on how employees should operate.

Consider an example with regard to cleaning instructions for a dispenser with a QR code. Cleaning instruction content tagged with metadata indicating Level 1 are specific to a particular product model and cleaning instruction content tagged with metadata indicating Level 2 could be company-specific cleaning instructions. The content/media can be tagged as Level 1 or Level 2, and depending which level to which the QR code is mapped, the QR code proxy system 102 can deliver the appropriate content/media. If the QR code associated with the dispenser in this example is mapped to Level 1, the cleaning instructions specific to the product model could be delivered upon scanning the QR code. However, if the dispenser is mapped to Level 2 in this example, the company-specific cleaning instructions would be delivered upon scanning the QR code. The media/content that is delivered upon scanning the QR code can be changed without changing the QR code on the dispenser; for example, the media/content can be changed by changing mapping of the QR code from Level 1 to Level 2, or vice versa. Thus, the QR code proxy system 102 can externally control the content/media that is delivered upon scanning the QR code associated with the dispenser without needing to change the QR code itself.

The proxy engine 202 is configured to receive a request for media/content from the computing device 112 upon scanning a QR code 110a, 110b, 110c, 110d, and determine which content/media assets to provide based on the QR code 110a, 110b, 110c, 110d that is scanned. As explained herein, in some embodiments, the proxy engine 202 determines the media/content to provide based on a content/media routing map 204 that establishes associations between QR codes 110a, 110b, 110c, or 110d and one or more content/media assets 106. For example, the content/media routing map 204 could be a table indexed based on QR codes. The table may associate each QR code with particular content/media asset(s), and entries in the table can be edited to change the content/media assets that are associated with each QR code. Upon doing a lookup in the content/media routing map 204 to determine one or more content/media assets associated with the QR code that has been scanned, the proxy engine 202 is configured to provide the one or more content/media assets to the computing device 112 that scanned the QR code.

As shown, the various components of the environment 200 may be embodied as hardware, firmware, software, or a combination thereof. As such, in some embodiments, one or more of the components of the environment 200 may be embodied as circuitry or collection of electrical devices (e.g., a proxy engine circuitry 202). Additionally or alternatively, in some embodiments, those components may be embodied as hardware, firmware, or other resources of the processor 118.

FIG. 3 illustrates at least one embodiment of the content/media routing map 204. In the example shown, the content/media routing map 204 includes an index column 300 labeled Global ID, which in this example is where each QR code (and/or global ID portion of the QR code) is stored in the map 204. Although the Global ID is embedded in a QR code in the embodiments described herein, other scannable identifiers, such as a bar code, RFID, etc. could be used to identify each dispenser. As with a static QR code that can be externally controlled to determine, adjust and control which content/media assets are provided upon scanning, the media selection of other static scannable identifiers could likewise control media/content that is provided upon scanning without changing the scannable identifier itself.

As shown, the content/media routing map 204 includes one or more content/media asset identifications 302 associated with each QR code (and/or global ID). In some embodiments, the content/media asset identifications 302 may be network locations where the content/media assets are located for each QR code. In the example shown, QR Code 1 304, QR Code 2 306, QR Code 3 308, QR Code 4 310, QR Code 5 312, and QR Code N 314 are associated with Level 1 316, Level 2 318, Level 3 320, Type 1 322, Type 2 324, and Type 3 326, respectively. In this example, when QR Code 1 is scanned, the proxy engine 202 will do a lookup of the content/media routing map 204 and determine a network address with Level 1 316 content/media assets. Likewise, the proxy engine 202 will do a lookup of the content/media routing map 204 for QR Code 2 306 and determine the network address associated with Level 2 318, and so forth. This allows the proxy engine 202 to determine the content/media assets corresponding to each QR code. Additionally, the content/media routing map 204 can be edited to change the content/media assets associated with QR codes to change the content/media assets that are provided upon scanning the QR codes, without needing to change the QR codes on the dispensers themselves. This allows the content/media assets of the QR codes to be externally controlled and managed.

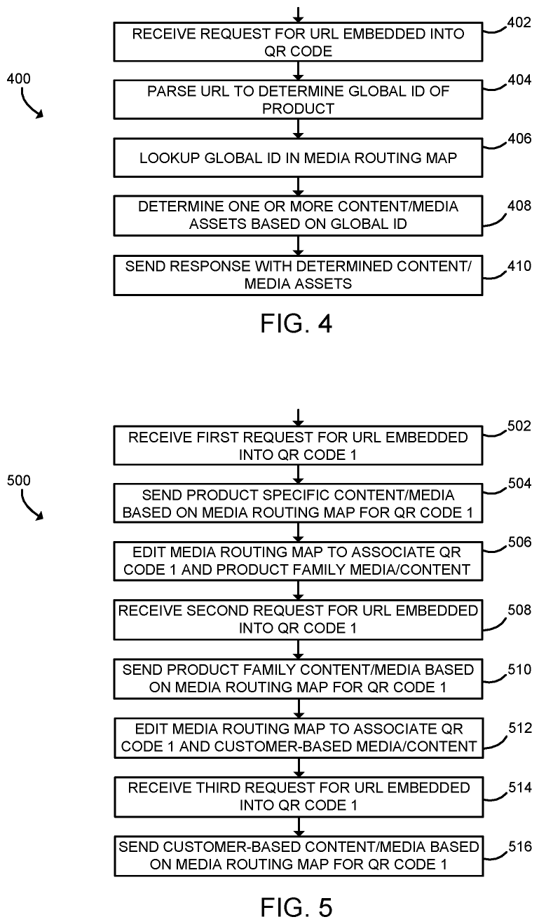

Referring now to FIG. 4, in use, the computing device 104 may execute a method 400 for determining content/media asset(s) to provide based on scanning a QR code. It should be appreciated that, in some embodiments, the operations of the method 400 may be performed by one or more components of the environment 200 as shown in FIG. 2, such as the QR code proxy system 102. The method 400 begins in block 402 in which the proxy engine 202 receives a request for a URL embedded into a QR code, which includes the global ID from the QR code. As mentioned, in some embodiments, the QR code for each dispenser (or certain sets of dispensers) may be unique, such that the QR code may include a global identifier that is used in the content/media routing map 204 to determine content/media assets associated with the QR code. For example, the QR code could be based on the serial number of the dispenser or a unique alphanumeric sequence. The method 400 advances to block 404 in which proxy engine 202 parses the URL to determine the global ID. The method 400 proceeds to block 406 in which the proxy engine 202 looks up the global ID in the content/media routing map 204 to determine one or more content/media assets corresponding to the global ID (e.g., QR code) (block 408). The proxy engine 202 then sends a response with the determined content/media assets (block 410).

Referring now to FIG. 5, in use, the computing device 104 may execute a method 500 for changing which content/media assets correspond with QR codes without needing to change the QR code itself of the dispenser. This allows a first media asset to be provided in response to scanning a first QR code, and then editing the content/media routing map 204 to change the first QR code to a second media asset, which then results in the second media asset in being provided in response to scanning the first QR code.

In the example shown in FIG. 5, there are two edits to the content/media routing map 204, which results in three different content/media assets being returned in response to scanning the same QR code. These two edits are described solely for purposes of example, and less or more edits to the content/media routing map 204 could be performed depending on the circumstances. As shown, the method 500 starts at block 502 in which the proxy engine 202 receives a first request, in response to scanning QR Code 1, for the URL embedded into QR Code 1. The method 500 advances to block 504 in which the proxy engine 202 sends product specific content/media (e.g., first media asset) based on the content/media routing map 204 lookup of QR code 1. Next, the method 500 proceeds to block 506 in which the content/media routing map 204 is edited to associate QR Code 1 with product family media/content (e.g., second media asset). Next, upon receiving a second request, in response to scanning QR Code 1 again, (block 508), the proxy engine 202 sends the product family content/media (second media asset) based on the edits in the content/media routing map 204 (block 510). The method 500 proceeds to block 512, in which the content/media routing map 204 is again edited to change the association of QR Code 1 to company-based media/content (e.g., third media asset). When the proxy engine 202 receives a third request, in response to scanning QR Code 1 again, (block 514), the proxy engine 202 sends the company-based content/media (third media asset) based on the second set of edits in the content/media routing map 204 (block 516).

### Examples

Illustrative examples of the technologies disclosed herein are provided below. An embodiment of the technologies may include any one or more, and any combination of, the examples described below.

Example 1 includes a QR code proxy system with a content/media routing map and a proxy engine. The content/media routing map is to establish an association between a plurality of dispensers each with a respective QR code and a plurality of digital dispenser assets. The proxy engine is to: (i) determine an identity of a dispenser of the plurality of dispensers based on a QR code; and (ii) respond with one or more digital dispenser assets based on the association established by the content/media routing map.

Example 2 includes the subject matter of Example 1, and wherein: the proxy engine is to edit associations between one or more of the plurality of dispensers and one or more of the plurality of digital dispenser assets.

Example 3 includes the subject matter of Examples 1-2, and wherein: to edit associations between the plurality of dispensers and the plurality of digital dispenser assets comprises editing associations between one or more QR codes and one or more digital dispenser assets.

Example 4 includes the subject matter of Examples 1-3, and wherein: the content/media routing map comprises a table that is indexed based on the plurality of QR codes.

Example 5 includes the subject matter of Examples 1-4, and wherein: each QR code embeds a global identifier that uniquely identifies a dispenser of the plurality of dispensers.

Example 6 includes the subject matter of Examples 1-5, and wherein: the global identifier comprises a unique alphanumeric sequence.

Example 7 includes the subject matter of Examples 1-6, and wherein: the global identifier comprises a serial number of a dispenser.

Example 8 includes the subject matter of Examples 1-7, and wherein: the proxy engine is to respond with a different digital dispenser asset based on one or more changes to the content/media routing map.

Example 9 includes the subject matter of Examples 1-8, and wherein: the content/media routing map is to establish one or more metadata parameters to organize of the plurality of digital dispenser assets.

Example 10 includes the subject matter of Examples 1-9, and wherein: the content/media routing map includes a first level metadata parameter corresponding to a product specific digital dispenser asset.

Example 11 includes the subject matter of Examples 1-10, and wherein: the content/media routing map includes a second level metadata parameter corresponding to a product family digital dispenser asset.

Example 12 includes the subject matter of Examples 1-11, and wherein: the content/media routing map includes a third level metadata parameter corresponding to a company specific digital dispenser asset.

Example 13 includes the subject matter of Examples 1-12, and wherein: the proxy engine is to change an association between a QR code and one of (1) a product specific digital dispenser asset; (2) a product family digital dispenser asset; or (3) a company specific digital dispenser asset by editing one or more entries regarding the QR code in the content/media routing map.

Example 14 includes one or more non-transitory, computer-readable storage media. The media has a plurality of instructions stored thereon that, in response to being executed, cause a computing device to: establish an association between a plurality of dispensers each with a respective QR code and a plurality of digital dispenser assets; determine an identity of a dispenser of the plurality of dispensers based on a QR code; and respond with one or more digital dispenser assets based on the association established by the content/media routing map.

Example 15 includes the subject matter of Example 14, and further comprising changing the association between a plurality of dispensers and the plurality of digital dispenser assets comprising editing associations between one or more of the plurality of dispensers and one or more of the plurality of digital dispenser assets.

Example 16 includes the subject matter of Examples 14-15, and wherein: to change association between the plurality of dispensers and the plurality of digital dispenser assets comprises editing associations between one or more QR codes and one or more digital dispenser assets.

Example 17 includes the subject matter of Examples 14-16, and wherein: the association between the plurality of dispensers and the plurality of digital dispenser assets comprises a table that is indexed based on the plurality of QR codes.

Example 18 includes the subject matter of Examples 14-17, and wherein: each QR code embeds a global identifier that uniquely identifies a dispenser of the plurality of dispensers.

Example 19 includes the subject matter of Examples 14-18, and wherein: the global identifier comprises a unique alphanumeric sequence.

Example 20 includes the subject matter of Examples 14-19, and wherein: the global identifier comprises a serial number of a dispenser.

Example 21 includes the subject matter of Examples 14-20, and further comprising one or more instructions to respond with a different digital dispenser asset based on one or more changes to the association between the plurality of dispensers and the plurality of digital dispenser assets.

Example 22 includes the subject matter of Examples 14-21, and further comprising one or more instructions to establish one or more metadata parameters to organize of the plurality of digital dispenser assets.

Example 23 includes the subject matter of Examples 14-22, and wherein: the one or more metadata parameters includes a first level metadata parameter corresponding to a product specific digital dispenser asset.

Example 24 includes the subject matter of Examples 14-23, and wherein: the one or more metadata parameters includes a second level metadata parameter corresponding to a product family digital dispenser asset.

Example 25 includes the subject matter of Examples 14-24, and wherein: the one or more metadata parameters includes a third level metadata parameter corresponding to a company specific digital dispenser asset.

Example 26 includes the subject matter of Examples 14-25, and further comprising one or more instruction to change an association between a QR code and one of (1) a product specific digital dispenser asset; (2) a product family digital dispenser asset; or (3) a company specific digital dispenser asset by editing one or more entries regarding the QR code in the content/media routing map.

Example 27 includes a computer-implemented method in which an association is established between a plurality of dispensers each with a respective QR code and a plurality of digital dispenser assets. The method includes the step of determining an identity of a dispenser of the plurality of dispensers based on a QR code. Additionally, the method includes responding with one or more digital dispenser assets based on the association established by the content/media routing map.

Example 28 includes the subject matter of Example 27, and further comprising changing the association between a plurality of dispensers and the plurality of digital dispenser assets comprising editing associations between one or more of the plurality of dispensers and one or more of the plurality of digital dispenser assets.

Example 29 includes the subject matter of Examples 27-28, and wherein: changing association between the plurality of dispensers and the plurality of digital dispenser assets comprises editing associations between one or more QR codes and one or more digital dispenser assets.

Example 30 includes the subject matter of Examples 27-29, and wherein: the association between the plurality of dispensers and the plurality of digital dispenser assets comprises a table that is indexed based on the plurality of QR codes.

Example 31 includes the subject matter of Examples 27-30, and wherein: each QR code embeds a global identifier that uniquely identifies a dispenser of the plurality of dispensers.

Example 32 includes the subject matter of Examples 27-31, and wherein: the global identifier comprises a unique alphanumeric sequence.

Example 33 includes the subject matter of Examples 27-32, and wherein: the global identifier comprises a serial number of a dispenser.

Example 34 includes the subject matter of Examples 27-33, and further comprising one or more instructions to respond with a different digital dispenser asset based on one or more changes to the association between the plurality of dispensers and the plurality of digital dispenser assets.

Example 35 includes the subject matter of Examples 27-34, and further comprising one or more instructions to establish one or more metadata parameters to organize of the plurality of digital dispenser assets.

Example 36 includes the subject matter of Examples 27-35, and wherein: the one or more metadata parameters includes a first level metadata parameter corresponding to a product specific digital dispenser asset.

Example 37 includes the subject matter of Examples 27-36, and wherein: the one or more metadata parameters includes a second level metadata parameter corresponding to a product family digital dispenser asset.

Example 38 includes the subject matter of Examples 27-37, and wherein: the one or more metadata parameters includes a third level metadata parameter corresponding to a company specific digital dispenser asset.

Example 39 includes the subject matter of Examples 27-38, and further comprising one or more instruction to change an association between a QR code and one of (1) a product specific digital dispenser asset; (2) a product family digital dispenser asset; or (3) a company specific digital dispenser asset by editing one or more entries regarding the QR code in the content/media routing map.

1. A QR code proxy system, the system comprising:
a content/media routing map to establish an association between a plurality of dispensers each with a respective QR code and a plurality of digital dispenser assets;
a proxy engine to: (i) determine an identity of a dispenser of the plurality of dispensers based on a QR code; and (ii) respond with one or more digital dispenser assets based on the association established by the content/media routing map.

2. The QR code proxy system of claim 1, wherein the proxy engine is to edit associations between one or more of the plurality of dispensers and one or more of the plurality of digital dispenser assets by changing associations between one or more QR codes and one or more digital dispenser assets.

3. The QR code proxy system of claim 1, wherein the content/media routing map comprises a table that is indexed based on the plurality of QR codes.

4. The QR code proxy system of claim 1, wherein each QR code embeds a global identifier that uniquely identifies a dispenser of the plurality of dispensers.

5. The QR code proxy system of claim 4, wherein the global identifier comprises one or more of: (i) a unique alphanumeric sequence; or (ii) a serial number of a dispenser.

6. The QR code proxy system of claim 1, wherein the proxy engine is to respond with a different digital dispenser asset based on one or more changes to the content/media routing map.

7. The QR code proxy system of claim 1, wherein the content/media routing map is to establish one or more metadata parameters to organize the plurality of digital dispenser assets, wherein the content/media routing map includes one or more of: (i) a first level metadata parameter corresponding to a product specific digital dispenser asset; (ii) a second level metadata parameter corresponding to a product family digital dispenser asset; or (iii) a third level metadata parameter corresponding to a company specific digital dispenser asset.

8. The QR code proxy system of claim 7, wherein the proxy engine is to change the association between a QR code and one of (1) a product specific digital dispenser asset; (2) a product family digital dispenser asset; or (3) a company specific digital dispenser asset by editing one or more entries regarding the QR code in the content/media routing map.

9. One or more non-transitory, computer-readable storage media comprising a plurality of instructions stored thereon that, in response to being executed, cause a computing device to:
establish an association between a plurality of dispensers each with a respective QR code and a plurality of digital dispenser assets;
determine an identity of a dispenser of the plurality of dispensers based on a QR code; and
respond with one or more digital dispenser assets based on the association established by the content/media routing map.

10. The one or more non-transitory, computer-readable storage media of claim 9, further comprising one or more instructions to change the association between a plurality of dispensers and the plurality of digital dispenser assets by editing associations between one or more QR codes and one or more digital dispenser assets.

11. The one or more non-transitory, computer-readable storage media of claim 9, wherein the association between the plurality of dispensers and the plurality of digital dispenser assets comprises a table that is indexed based on the plurality of QR codes.

12. The one or more non-transitory, computer-readable storage media of claim 9, wherein each QR code embeds a global identifier that uniquely identifies a dispenser of the plurality of dispensers.

13. The one or more non-transitory, computer-readable storage media of claim 12, wherein the global identifier comprises one or more of: (i) a unique alphanumeric sequence; or (ii) a serial number of a dispenser.

14. The one or more non-transitory, computer-readable storage media of claim 9, further comprising one or more instructions to respond with a different digital dispenser asset based on one or more changes to the association between the plurality of dispensers and the plurality of digital dispenser assets.

15. The one or more non-transitory, computer-readable storage media of claim 9, further comprising one or more instructions to establish one or more metadata parameters to organize of the plurality of digital dispenser assets, wherein the one or more metadata parameters includes one or more of: (i) a first level metadata parameter corresponding to a product specific digital dispenser asset; (ii) a second level metadata parameter corresponding to a product family digital dispenser asset; or (iii) a third level metadata parameter corresponding to a company specific digital dispenser asset.

16. The one or more non-transitory, computer-readable storage media of claim 15, further comprising one or more instructions to change the association between a QR code and one of (1) a product specific digital dispenser asset; (2) a product family digital dispenser asset; or (3) a company specific digital dispenser asset by editing one or more entries regarding the QR code in the content/media routing map.

17. A computer-implemented method comprising:
establishing, using one or more computing devices, an association between a plurality of dispensers each with a respective QR code and a plurality of digital dispenser assets;
determining, using the one or more computing devices, an identity of a dispenser of the plurality of dispensers based on a QR code; and
responding, using the one or more computing devices, with one or more digital dispenser assets based on the association established by the content/media routing map.

18. The method of claim 17, further comprising changing the association between a plurality of dispensers and the plurality of digital dispenser assets comprising editing associations between one or more of the plurality of dispensers and one or more of the plurality of digital dispenser assets by editing associations between one or more QR codes and one or more digital dispenser assets.

19. The method of claim 17, wherein the association between the plurality of dispensers and the plurality of digital dispenser assets comprises a table that is indexed based on the plurality of QR codes.

20. The method of claim 17, wherein each QR code embeds a global identifier that uniquely identifies a dispenser of the plurality of dispensers.

21. The method of claim 20, wherein the global identifier comprises one or more of: (i) a unique alphanumeric sequence; or (ii) a serial number of a dispenser a unique alphanumeric sequence.

22. The method of claim 17, further comprising responding with a different digital dispenser asset based on one or more changes to the association between the plurality of dispensers and the plurality of digital dispenser assets.

23. The method of claim 17, further comprising establishing one or more metadata parameters to organize of the plurality of digital dispenser assets, wherein the one or more metadata parameters includes one or more of: (i) a first level metadata parameter corresponding to a product specific digital dispenser asset; (ii) a second level metadata parameter corresponding to a product family digital dispenser asset; or (iii) a third level metadata parameter corresponding to a company specific digital dispenser asset.

24. The method of claim 23, further comprising changing the association between a QR code and one of (1) a product specific digital dispenser asset; (2) a product family digital dispenser asset; or (3) a company specific digital dispenser asset by editing one or more entries regarding the QR code in the content/media routing map.
